(19) United States
(12) Patent Application Publication
(10) Pub. No.: US 2024/0164366 A1
(43) Pub. Date: May 23, 2024

(54) KIT TO TRACK BALLISTICALLY INJURED GAME

(71) Applicant: Rich Gonzalez, Rocky Point, NC (US)

(72) Inventor: Rich Gonzalez, Rocky Point, NC (US)

(73) Assignee: Rich Gonzalez, Rocky Point, NC (US)

(21) Appl. No.: 18/427,113

(22) Filed: Jan. 30, 2024

Related U.S. Application Data
(63) Continuation-in-part of application No. 17/866,819, filed on Jul. 18, 2022.

(51) Int. Cl. A01M 31/00; B05C 19/00

(52) U.S. Cl. CPC A01M 31/00; B05C 19/008

(57) ABSTRACT

Embodiments of the instant disclosure relate to a kit to track ballistically injured game. The kit includes a paint applicator and directional signage device. The paint applicator dispenses marking material. The directional signage device demountably couples to the paint applicator; includes a shaped void in the form of a directional symbol; and displays the shaped void on a surface when the directional signage device is positioned proximate to the surface and the marking material is applied to the directional signage device in a manner to flow through the shaped void onto the surface. The kit includes an engaged state wherein the directional signage device is demountably coupled to the paint applicator and a disengaged state wherein the directional signage device is demountably decoupled from the paint applicator. The directional signage device comprises a layer formed of a resilient flexible material shaped with a width-wise arc.

### CROSS-REFERENCE TO RELATED APPLICATIONS

This application is a continuation-in-part of U.S. patent application Ser. No. 17/866,819, filed Jul. 18, 2022. This application is hereby incorporated herein by reference.

### BACKGROUND

The instant disclosure relates generally to tracking kits and specifically to kits to track ballistically injured game. The nature and severity of a ballistic wound depends on the characteristics of the projectile and of the tissue(s) through which it travels. In addition to the mass and velocity of the projectile, its orientation and whether it fragments or deforms affect the nature of the wound as well as the quantity and periodicity of the hemalogical material discharged therefrom. Tracking ballistically injured game typically involves affixing colored (e.g., fluorescent) flags/tags to foliage to mark the presence of hematological material in case darkness or weather force one to cease their search. Unfortunately, such flags/tags can be accidentally removed/dislodged or become discolored. Consumers would benefit from a solution to mark the presence of hematological material that resists removal and/or discoloration.

### BRIEF DESCRIPTION OF THE DRAWINGS

FIG. 1 depicts a kit to track ballistically injured game in a disengaged state, in accordance with some embodiments.

FIG. 2 depicts the kit of FIG. 1 in an engaged state, in accordance with other embodiments.

FIG. 3 depicts a directional signage device in a curled state, in accordance with certain embodiments.

FIG. 4 depicts a directional signage device in an extended state, in accordance with yet still other embodiments.

FIG. 5 illustrates a manner of marking hematological material using the directional signage device and paint applicator of the kit of FIG. 1, in accordance with some embodiments.

FIG. 6 depicts a kit to track ballistically injured game in a disengaged state, in accordance with other embodiments.

FIG. 7 depicts the kit of FIG. 6 in an engaged state, in accordance with certain embodiments.

FIG. 8 depicts a directional signage device with a top surface cap, in accordance with yet still other embodiments.

FIG. 9 depicts a directional signage device with a cap over the top surface, in accordance with some embodiments.

FIG. 10 illustrates a manner of marking hematological material using the directional signage device and paint applicator of the kit of FIG. 6, in accordance with certain embodiments.

FIG. 11 illustrates a process of marking hematological material using the kit of FIG. 6, in accordance with other embodiments.

### DETAILED DESCRIPTION

The descriptions of the various embodiments of the instant disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Certain terminology may be employed in the following description for convenience rather than for any limiting purpose. For example, the terms “forward” and “rearward,” “front” and “rear,” “right” and “left,” “upper” and “lower,” and “top” and “bottom” designate directions in the drawings to which reference is made, with the terms “inward,” “inner,” “interior,” or “inboard” and “outward,” “outer,” “exterior,” or “outboard” referring, respectively, to directions toward and away from the center of the referenced element, the terms “radial” or “horizontal” and “axial” or “vertical” referring, respectively, to directions or planes which are perpendicular, in the case of radial or horizontal, or parallel, in the case of axial or vertical, to the longitudinal central axis of the referenced element, the terms “proximate” and “distal” referring, respectively, to positions or locations that are close or away from a point of reference, and the terms “downstream” and “upstream” referring, respectively, to directions in and opposite that of fluid flow. Terminology of similar import other than the words specifically mentioned above likewise is to be considered as being used for purposes of convenience rather than in any limiting sense.

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows. Angles may be designated as “included” as measured relative to surfaces or axes of an element and as defining a space bounded internally within such element therebetween, or otherwise without such designation as being measured relative to surfaces or axes of an element and as defining a space bounded externally by or outside of such element therebetween. Generally, the measures of the angles stated are as determined relative to a common axis, which axis may be transposed in the figures for purposes of convenience in projecting the vertex of an angle defined between the axis and a surface which otherwise does not extend to the axis. The term “axis” may refer to a line or to a transverse plane through such line as will be apparent from context.

The instant disclosure relates generally to tracking kits and specifically to kits to track ballistically injured game. The nature and severity of a ballistic wound depends on the characteristics of the projectile and of the tissue(s) through which it travels. In addition to the mass and velocity of the projectile, its orientation and whether it fragments or deforms affect the nature of the wound as well as the quantity and periodicity of the hemalogical material discharged therefrom. Tracking ballistically injured game typically involves affixing colored (e.g., fluorescent) flags/tags to foliage to mark the presence of hematological material in case darkness or weather force one to cease their search. Unfortunately, such flags/tags can be accidentally removed/dislodged or become discolored. Consumers would benefit from a solution to mark the presence of hematological material that resists removal and/or discoloration.

Embodiments of the instant disclosure seek to provide a kit to track ballistically injured game. Other aspects of the instant disclosure seek to provide handheld paint applicators that can be used to visually mark hemalogical material discharged from ballistically injured game. Additional aspects of the instant disclosure seek to provide directional signage devices that can be used (e.g., with the disclosed handheld paint applicators) to project directional symbols on to surfaces (e.g., proximate to the discharged hemalogical material) to aid in tracking said ballistically injured game. Certain aspects of the instant disclosure seek to provide directional signage devices that can demountably couple to such handheld paint applicators to provide kits to track ballistically injured game that is compact, man-portable, and easy for the average consumer to use.

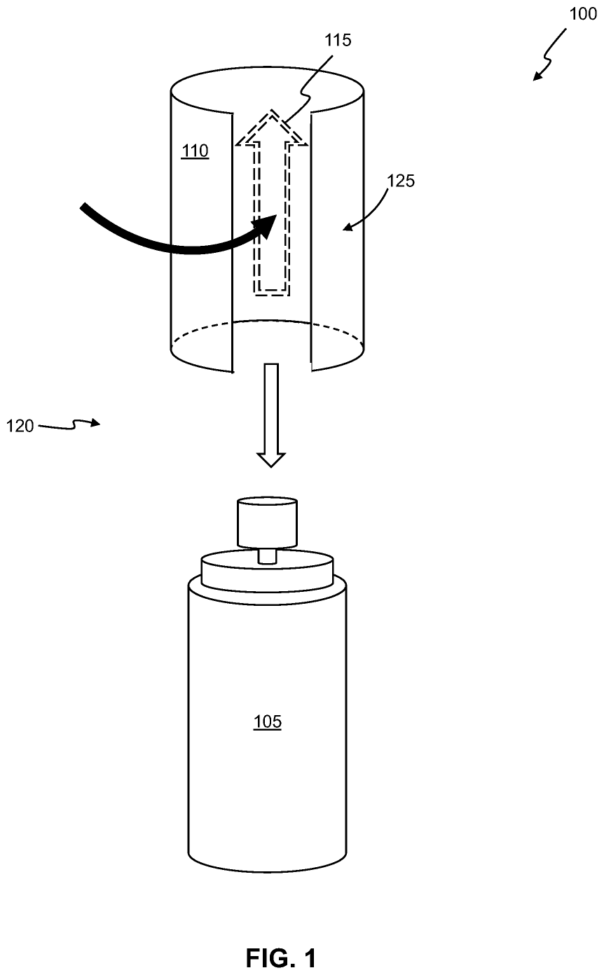

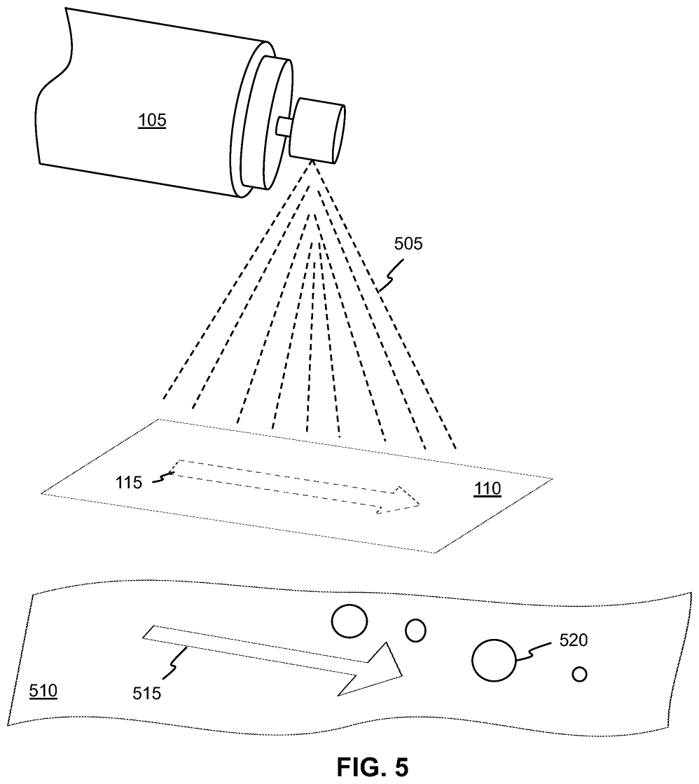

Turning now to FIGS. 1-5. FIG. 1 depicts a kit, generally 100, in a disengaged state 120, in accordance with some embodiments. The kit 100 is typically used to track ballistically injured game as disclosed herein. The kit 100 preferably includes a paint applicator 105 and a directional signage device 110 demountably coupled thereto. The kit 100 preferably includes an engaged state (discussed further below) and the disengaged state 120. In the disengage state 120, the directional signage device 110 is preferably demountably decoupled from the paint applicator 105. The paint applicator 105 can be a handheld, sealed, pressurized container that contains a marking material that is released in an aerosol spray when an attached valve button is depressed. In other words, the paint applicator 105 dispenses the marking material. The paint applicator 105 can include a propellant that pressurizes the container. When the pressure holding the gas is released through the valve, the marking material is released as a fine spray.

In other embodiments, the paint applicator 105 can be a container that can squirt, spray, and/or mist fluids (e.g., a spray bottle), such as the marking material. Here, the paint applicator 105 can use a positive displacement pump that acts directly on the marking material. The displacement pump is configured to draw the marking material up a siphon tube from the bottom of the container of the paint applicator 105 that is holding the marking material and force it through a nozzle. The nozzle can be adjustable, so as to select between squirting a stream, aerosolizing a mist, or dispensing a spray (i.e., of the marking material). In embodiments that use the positive displacement pump, the dispensing can be powered by the user's efforts, as opposed to the pressurized container, where the user simply actuates a valve to dispense the marking material under pressure. The paint applicator 105 includes a container that stores the marking material. The container can have any geometric shape that satisfies one or more embodiments of the instant disclosure (e.g., cylindrical, ovular, polygonal, or two or more thereof). The nozzle or valve can be located at the top, side, or bottom of the paint applicator. The marking material is preferably dispensed laterally relative to the paint applicator 105.

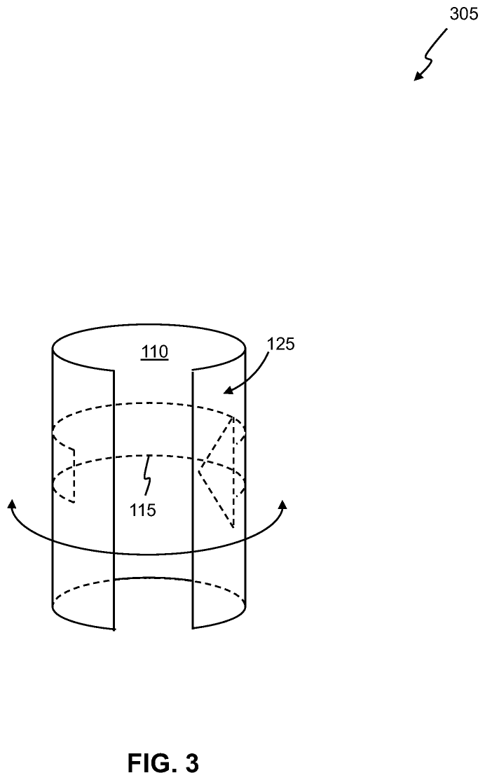

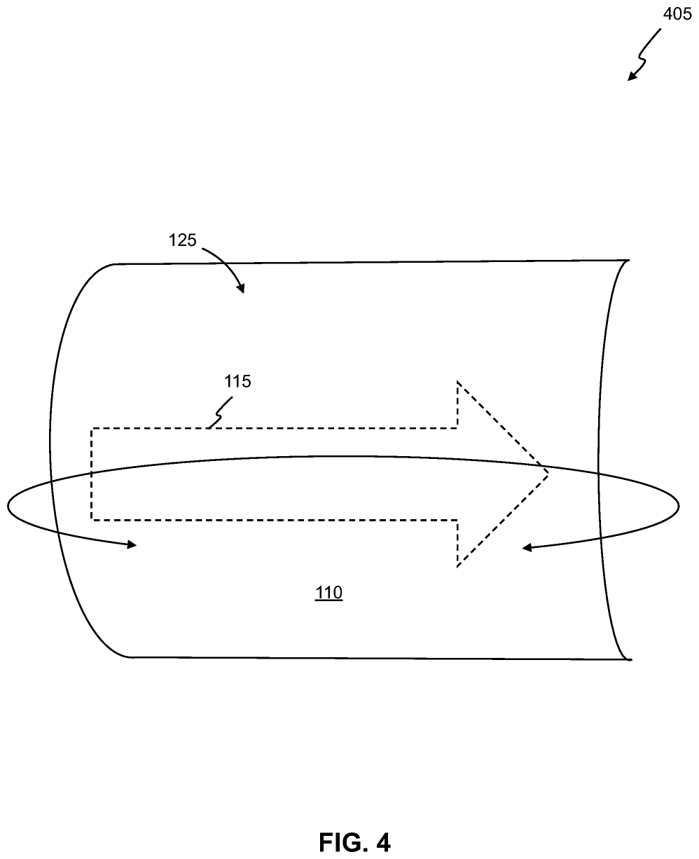

The marking material is preferably a liquid substance that can include a paint (e.g., paints known in the arts, non-fluorescent paints, Amido Black, ninhydrin, etc.), a fluorescent material, a chemiluminescent material (e.g., luminol, fluorescent benzazole dyes, etc.) and/or an infrared-reflective material. The directional signage device 110 includes a shaped void 115 in the form of a directional symbol (e.g., a geometric and/or text-based symbol that denotes a direction). In general, the directional signage device 110 displays the shaped void 115 on a surface when the directional signage device 110 is positioned proximate to the surface and the marking material is applied to the directional signage device 110 in a manner to flow through the shaped void 115 onto the surface. In some embodiments, the directional signage device 110 includes a layer 125 formed of a resilient flexible material shaped with a width-wise arc (as seen in FIG. 4). The layer 125 includes the shaped void 115 positioned therein. The layer 125 presents a linear orientation (e.g., FIG. 4) in an extended configuration 405 and a coiled orientation (e.g., FIG. 3) when in an enveloped configuration 305 initiated by deforming the width-wise arc.

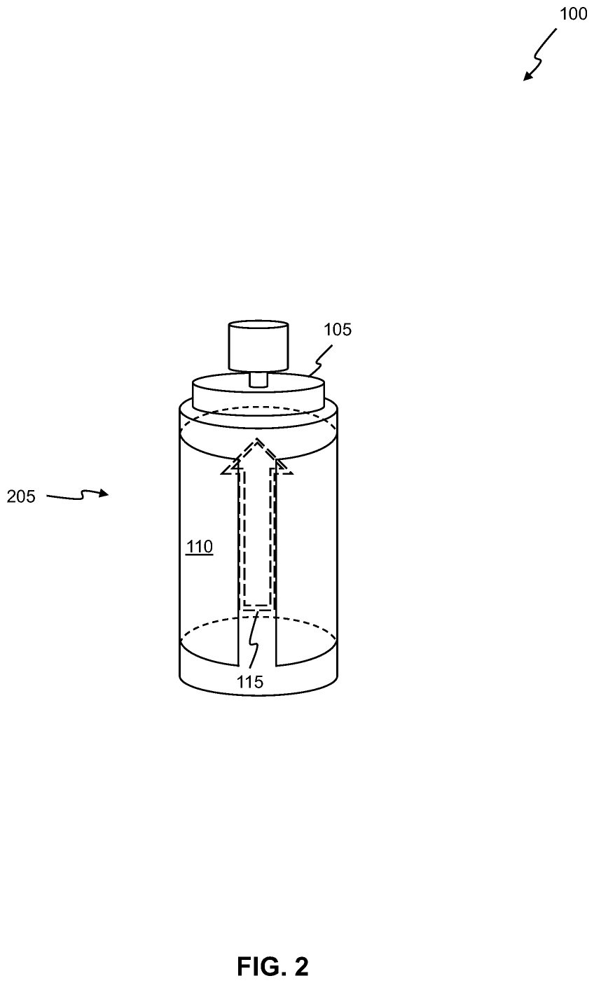

As seen in FIG. 2, the directional signage device 110 preferably demountable attaches to the cylindrical body of the paint applicator 105 when in the enveloped configuration 305. In other words, in the engaged state 205, the directional signage device 110 is demountably coupled to the paint applicator. The shaped void 115 can extend lengthwise along the layer 125 (as shown in FIG. 3) or widthwise (as shown in FIGS. 1-2). The shaped void 110 can be a void in the form of the directional symbol. Alternatively, as shown in FIG. 1, the shaped void 110 can be a perforation configured in the form the directional symbol. Here, the shaped void 110 can be removed from the directional signage device 110 along the perforations when pressure is applied normal thereto and thereby results in a directional void in the form of the directional symbol.

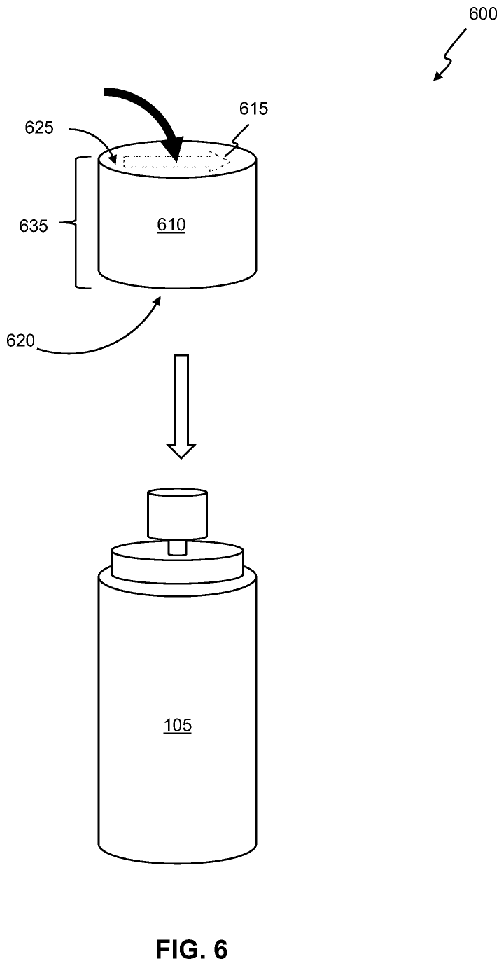

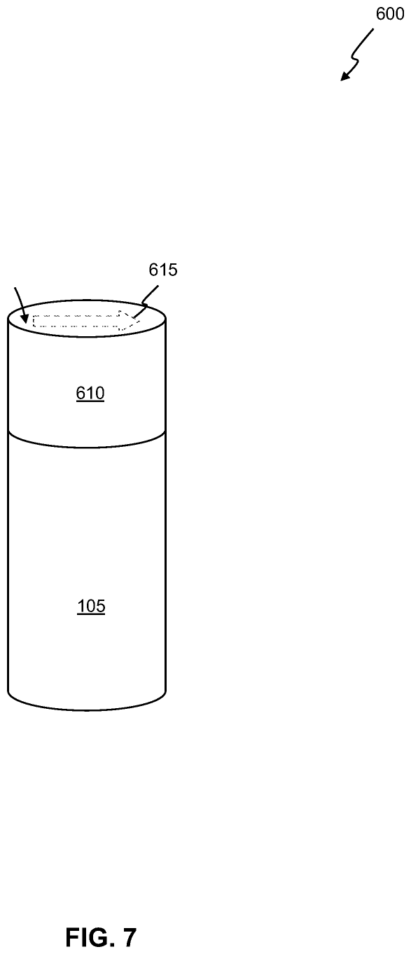

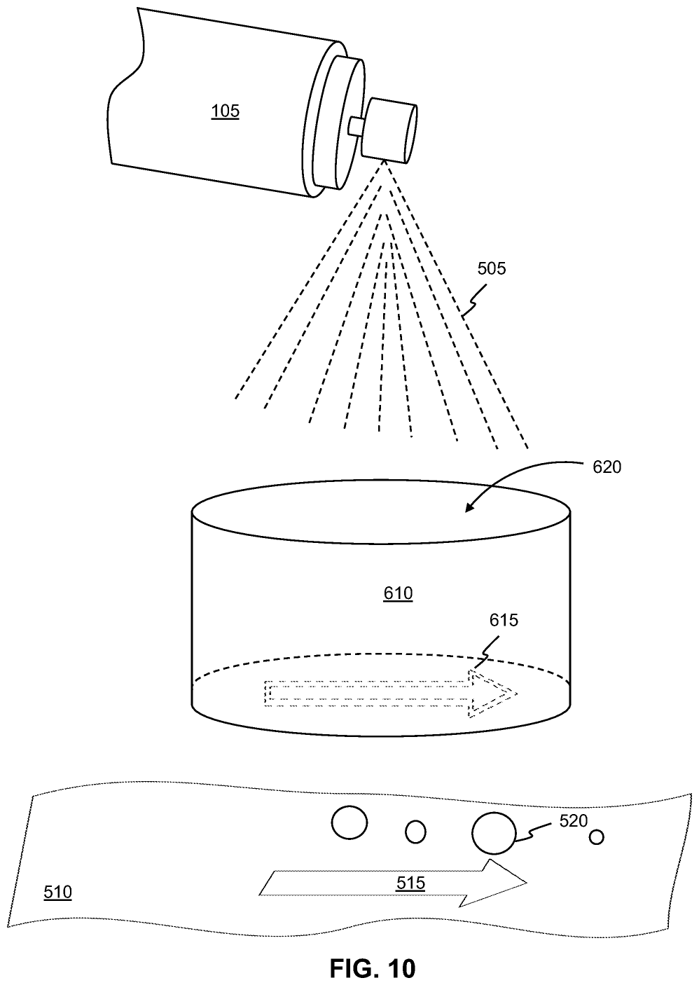

Referring now to FIGS. 6-10. Here, the kit 600 includes a directional signage device 610, the paint applicator 105, a disengaged state 630 and an engaged state 730. The directional signage device 610 is configured as a cap (e.g., a cover or top) having a cylindrical body 635 that includes an open bottom 620 and a top surface 625. The directional signage device 610 demountably couples to the paint applicator 105. Specifically, in the disengage state 630, the directional signage device 610 is demountably decoupled from the paint applicator 105; and in the engaged state 730, the directional signage device 610 is demountably coupled to the paint applicator 105. A shaped void 615 is preferably embedded in the top surface. In some embodiments, the shaped void 615 can be removed by applying pressure normal to the top surface to dislodge the shaped void 615 to thereby result in a directional void in the form of the directional symbol.

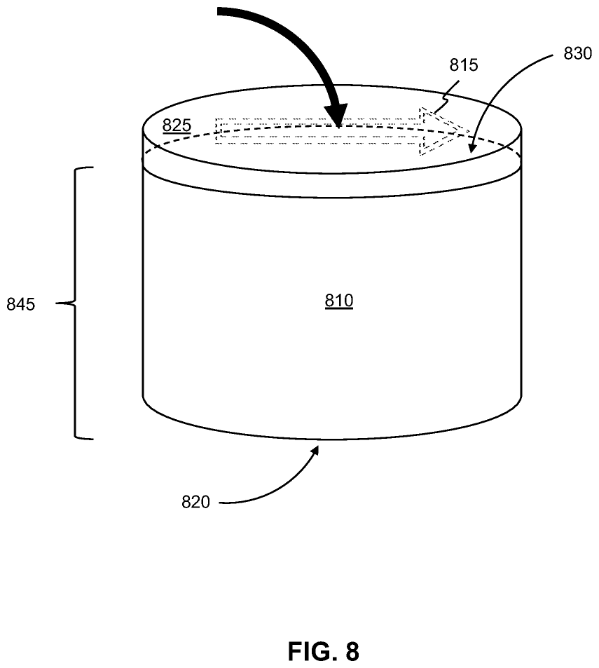

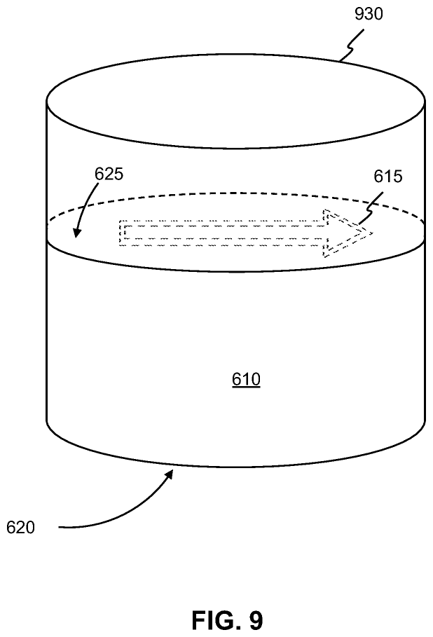

The cylindrical body is configured to demountably couple to an end of the paint applicator 105 via the open bottom 620. In some embodiments, the directional signage device 610 can be configured to receive a cap 930 that demountably attached to the top surface 625 when axially aligned proximate to the directional signage device 610 and snapped together thereto (as shown in FIG. 9). The cap 930 functions as a protective cover. Alternatively, as shown in FIG. 8, kits can include directional signage device 810, which has a cylindrical body 465. The cylindrical body 845 has an open bottom 820 and an open top 830. Top surface 825 demountably attaches to the open top 830 when the top surface 825 comes together with the cylindrical body 845 and is snapped thereto.

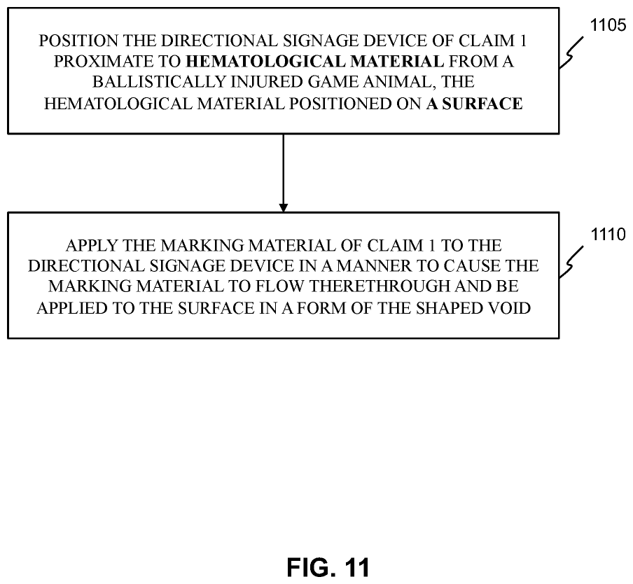

FIG. 11 illustrates operational steps of a method to track ballistically injured game, according to certain embodiments. The operational steps can apply to any of the kits and/or components thereof disclosed above. For example, to begin the process, the directional signage device must be decoupled from the paint applicator (i.e., the kit 100 or 600 must be in the disengaged state 120 or 630, respectively). At Step 1105, the directional signage device (e.g., the directional signage device 110 or 610) is positioned proximate to hematological material 520 (e.g., from a ballistically injured game animal), the hematological material 520 is positioned on a surface 510 (e.g., any surface where game roams including, but not limited to, plains, forests, tundra, and jungle terrain). At Step 1110, the marking material 505 is applied to the directional signage device (e.g., the directional signage device 510 or the directional signage device 610) in a manner to cause the marking material 505 to flow therethrough (i.e., through the shaped void) and be applied to the surface 510 in a form of the shaped void (e.g., the shaped void 115 or 615). In other words, when the marking material 505 is sprayed through the directional signage device onto the surface 510, it forms directional image 515 on to surface 510.

Based on the foregoing, a kit and method to track ballistically injured game have been disclosed in accordance with the instant disclosure. However, numerous modifications and substitutions can be made without deviating from the scope of the instant disclosure. Therefore, the instant disclosure has been presented by way of example and not limitation.

What is claimed is:

1. A kit to track ballistically injured game, comprising:
a paint applicator;
a directional signage device;
wherein
the paint applicator dispenses marking material;
the directional signage device
demountably couples to the paint applicator;
comprises a shaped void in the form of a directional symbol; and
displays the shaped void on a surface when the directional signage device is positioned proximate to the surface and the marking material is applied to the directional signage device in a manner to flow through the shaped void onto the surface;
the kit comprises an engaged state and a disengaged state;
in the engaged state, the directional signage device is demountably coupled to the paint applicator; and
in the disengage state, the directional signage device is demountably decoupled from the paint applicator.

2. The kit of claim 1, wherein
the directional signage device comprises a layer formed of a resilient flexible material shaped with a width-wise arc;
the layer
comprises the shaped void positioned therein; and
the layer presents a linear orientation in an extended configuration and presents a coiled orientation when in an enveloped configuration initiated by deforming the width-wise arc.

3. The kit of claim 2, wherein
the paint applicator comprises a cylindrical body; and
the directional signage demountable attaches to the cylindrical body when in the enveloped configuration.

4. The kit of claim 2, wherein
the shaped void extends lengthwise along the layer.

5. The kit of claim 1, wherein
the shaped void comprises a void in the form of the directional symbol.

6. The kit of claim 1, wherein
the shaped void comprises a perforation in the form the directional symbol.

7. The kit of claim 6, wherein
the shaped void is removed from the directional signage device along the perforations when pressure is applied normal thereto and thereby results in a directional void in the form of the directional symbol.

8. The kit of claim 1, wherein
the directional signage device comprises a cylindrical body;
the cylindrical body comprises an open bottom and a top surface;
the cylindrical body demountably couples to an end of the paint applicator via the open bottom; and
the shaped void is embedded in the top surface.

9. The kit of claim 8, wherein
the cylindrical body comprises an open top; and
the top surface demountably attaches to the open top when the top surface comes together with the cylindrical body and is snapped thereto.

10. The kit of claim 1, wherein
the directional signage device comprises a cylindrical body and a cap;
the cylindrical body comprises an open bottom and a top surface;
the shaped void is embedded in the top surface;
the cylindrical body demountably couples to an end of the paint applicator via the open bottom; and
the cap demountably attached to the top surface when axially aligned proximate thereto and snapped thereto.

11. The kit of claim 1, wherein
the marking material comprises one or more of a paint, a fluorescent material, a chemiluminescent material, and an infrared-reflective material.

12. A method to track ballistically injured game, comprising:
positioning the directional signage device of claim 1 proximate to hematological material from a ballistically injured game animal, the hematological material positioned on a surface; and
applying the marking material of claim 1 to the directional signage device in a manner to cause the marking material to flow therethrough and be applied to the surface in a form of the shaped void.
